(19) United States
(12) Patent Application Publication
(10) Pub. No.: US 2013/0077307 A1
(43) Pub. Date: Mar. 28, 2013

(54) ILLUMINATION DEVICE

(71) Applicant: Hiroyuki Yamamoto, Osaka-shi (JP)

(72) Inventor: Hiroyuki Yamamoto, Osaka-shi (JP)

(73) Assignee: SHARP KABUSHIKI KAISHA, Osaka-shi Osaka (JP)

(21) Appl. No.: 13/703,251

(22) PCT Filed: Apr. 26, 2011
(86) PCT No.: PCT/JP2011/060163

§ 371 Date: Dec. 10, 2012

(30) Foreign Application Priority Data
Jun. 11, 2010 (JP) 2010-134348

(51) Int. Cl. F21V 21/00; F21V 7/00; F21V 5/00

(52) U.S. Cl. CPC F21V 21/00; F21V 5/007; F21V 7/0083
USPC 362/244; 362/247; 362/249.06

(57) ABSTRACT

A lighting device (1) makes it possible to manufacture a plurality of models at a low cost, which plurality of models are different from each other in brightness. The lighting device (1) includes a plurality of light-emitting sections (4) each having LEDs (8a, 8b) that emit light. At least one of the light-emitting sections (4) have a plurality of mounting areas (7a, 7b) designed to be provided with the respective LEDs (8a, 8b). By changing, to one or two, the number of LEDs to be provided in each of the light-emitting sections (4), it is possible to manufacture, by use of identical transmission units (3), a plurality of types of illumination devices that are different from each other in brightness.

### TECHNICAL FIELD

The present invention relates to an illumination device, specifically an illumination device employing an LED as a light source.

### BACKGROUND ART

An LED (light-emitting diode) has advantages such as a long service life and low power consumption. As such, an illumination device employing an LED as a light source instead of an incandescent lamp or a fluorescent lamp has been developed recently.

(a) of FIG. 8 is a plan view of a conventional illumination device 101 viewed from a light-emitting direction, and (b) of FIG. 8 is a cross-sectional view of a part of the illumination device 101. As illustrated in (a) of FIG. 8 and (b) of FIG. 8, (i) the illumination device 101 includes seven light-emitting sections 104 which are arranged, in a form of a close-packed cubic lattice, on an emitting surface covered with a transmission unit 103, and (ii) a single LED 108 is mounted in each of the light-emitting sections 104.

Specifically, as illustrated in (b) of FIG. 8, each of the light-emitting sections 104 includes the LED 108, a reflective surface 1031 which is formed on an inner surface of the transmission unit 103, and a lighting lens 1032 which is formed in a position facing the LED 108. The LED 108 is mounted on an LED substrate 107. The reflective surface 1031 and the lighting lens 1032 are integrally formed as a part of the transmission unit 103. The reflective surface 1031 is provided on the inner surface of the transmission unit 103 so as to surround the LED 108. Light received from the LED 108 is reflected from the reflective surface 1031 toward the light-emitting section 104 (so as to get away from the LED 108). The lighting lens 1032 is formed in a convex shape toward the LED 108 so as to increase directivity of light received from the LED 108.

This allows the illumination device 101 to serve as a planer light source that emits light almost uniformly when viewed from a distance. A similar configuration to a configuration of the illumination device 101 is disclosed, for example, in Patent Literature 1.

### CITATION LIST

### Patent Literature

[Patent Literature 1]

Japanese Patent Application Publication, Tokukai, No. 2004-134319 A (Publication Date: Apr. 30, 2004)

### SUMMARY OF INVENTION

### Technical Problem

However, the conventional art described above has a problem that in a case where a plurality of types of illumination devices, which are different from each other in brightness, are manufactured, a part of the illumination devices is impossible to standardize.

An output (brightness) of an illumination device depends on the number of LEDs used in the illumination device. For example, the illumination device 101 illustrated in (a) of FIG. 8 employs seven LEDs. In a case where an illumination device having an output larger than that of the illumination device 101 is manufactured, it is necessary to increase the number of light-emitting sections 104 each of which is designed to be provided with an LED. As such, the transmission unit 103 employed in the illumination device 101 cannot be employed as it is in the illumination device having the larger output.

In a case where an illumination device having an output smaller than that of the illumination device 101 is manufactured, it is possible to reduce the number of LEDs for the entire illumination device by adopting a design in which no LED is mounted in some of the light-emitting sections 104 in the illumination device 101. In this case, however, no light is emitted from a light-emitting section in which no LED is mounted. As such, luminance unevenness is generated on a light-emitting surface of the illumination device. This is undesirable in terms of appearance. Accordingly, even in the case where the illumination device having the output smaller than that of the illumination device 101 is manufactured, it is necessary to create a new illumination device 101 having a smaller number of light-emitting sections 104. As such, the transmission unit 103 employed in the illumination device 101 cannot be employed in the new illumination device 101.

As described above, in a case where a plurality of types of illumination devices that are different from each other in brightness are manufactured, it is necessary to use different transmission units for the respective types of illumination devices. This makes it difficult to reduce a manufacturing cost for the illumination device.

The present invention is accomplished in order to solve the problem. An object of the present invention is to provide an illumination device which makes it possible to manufacture a plurality of models of the illumination device at a low cost, which plurality of models are different from each other in brightness.

### Solution to Problem

In order to attain the object, an illumination device of the present invention is an illumination device including: a plurality of light sources; a substrate; and a plurality of light-emitting sections for emitting light received from the plurality of light sources, the plurality of light-emitting sections facing the substrate, the substrate having, at a position corresponding to each of the plurality of light-emitting sections, a set of a plurality of mounting areas each being designed to be provided with a single light source, the plurality of light sources being provided in such a manner that at least one light source is provided in the set of the plurality of mounting areas provided for each of the plurality of light-emitting sections.

In the configuration described above, the substrate has, at the position corresponding to each of the plurality of light-emitting sections, the set of the plurality of mounting areas each being designed to be provided with a single light source. That is, since the plurality of mounting areas are provided, it is possible to select the number of light sources to be provided within the number of the mounting areas. As such, by changing the number of the light sources to be provided in each of the light-emitting sections, to each of which the set of the plurality of mounting areas corresponds, it becomes possible to manufacture a plurality of types of illumination devices that are different from each other in total number of the light sources to be employed.

Moreover, by providing at least one light source on the substrate at a position corresponding to each of the light-emitting sections, that is, by changing, to one (1) or a plural number, the number of light sources to be provided in each of the light-emitting sections, to each of which the set of the plurality of mounting areas corresponds, it becomes possible to manufacture a plurality of types of illumination devices (i) which are different from each other in brightness and (ii) in each of which light is emitted from all of the light-emitting sections. Further, since the number of light-emitting sections is equal among the plurality of types of illumination devices. This makes it possible to standardize, among the illumination devices, a transmission plate for forming a light-emitting section. Accordingly, it becomes possible to provide an illumination device which makes it possible to manufacture a plurality of models of the illumination device at a low cost, which plurality of models are different from each other in brightness.

### Advantageous Effects of Invention

As described above, an illumination device of the present invention is an illumination device including: a plurality of light sources; a substrate; and a plurality of light-emitting sections for emitting light received from the plurality of light sources, the plurality of light-emitting sections facing the substrate, the substrate having, at a position corresponding to each of the plurality of light-emitting sections, a set of a plurality of mounting areas each being designed to be provided with a single light source, the plurality of light sources being provided in such a manner that at least one light source is provided in the set of the plurality of mounting areas provided for each of the plurality of light-emitting sections. Therefore, it is possible to provide an illumination device which makes it possible to manufacture a plurality of models of the illumination device at a low cost, which plurality of models are different from each other in brightness.

### BRIEF DESCRIPTION OF DRAWINGS

FIG. 1

FIG. 1 is a perspective view illustrating an illumination device of the present invention.

FIG. 2

FIG. 2 is an exploded perspective view illustrating the illumination device illustrated in FIG. 1.

FIG. 3

(a) of FIG. 3 is a lateral view illustrating the illumination device illustrated in FIG. 1. (b) of FIG. 3 is a cross-sectional view illustrating the illumination device. (c) of FIG. 3 is an enlarged cross-sectional view of a part of the illumination device.

FIG. 4

(a) of FIG. 4 is a perspective view illustrating a transmission unit employed in the illumination device, and (b) of FIG. 4 is an enlarged view of a part of the transmission plate.

FIG. 5

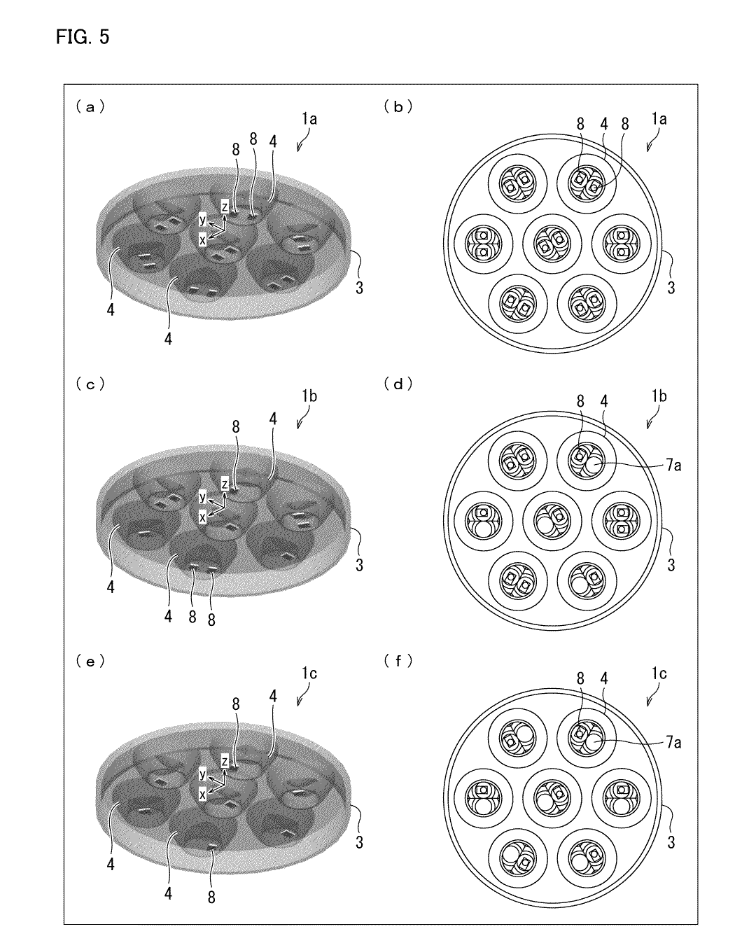

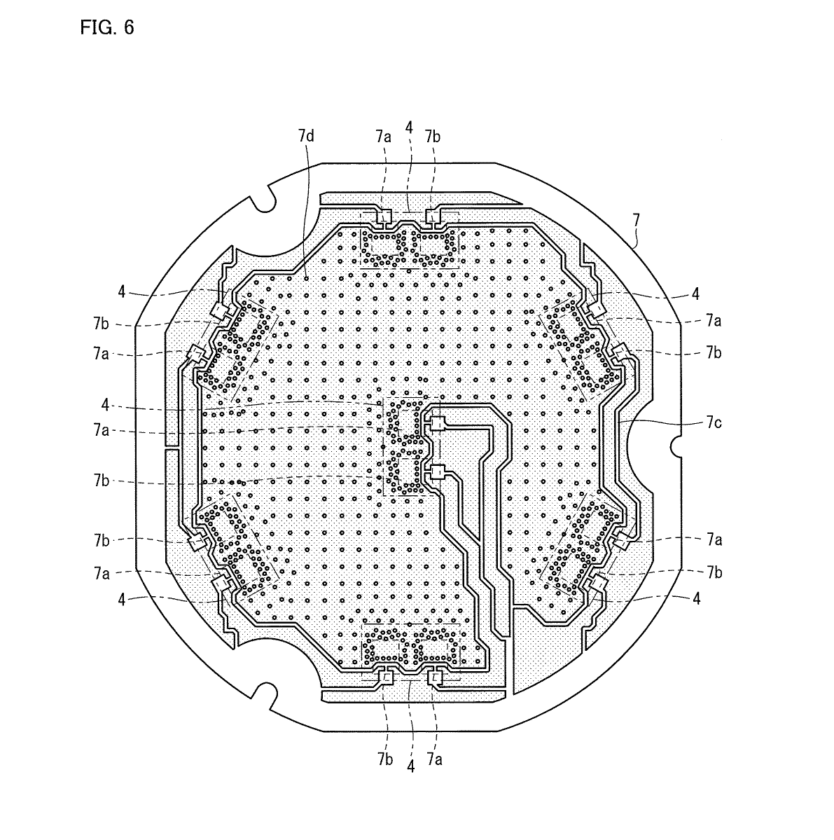

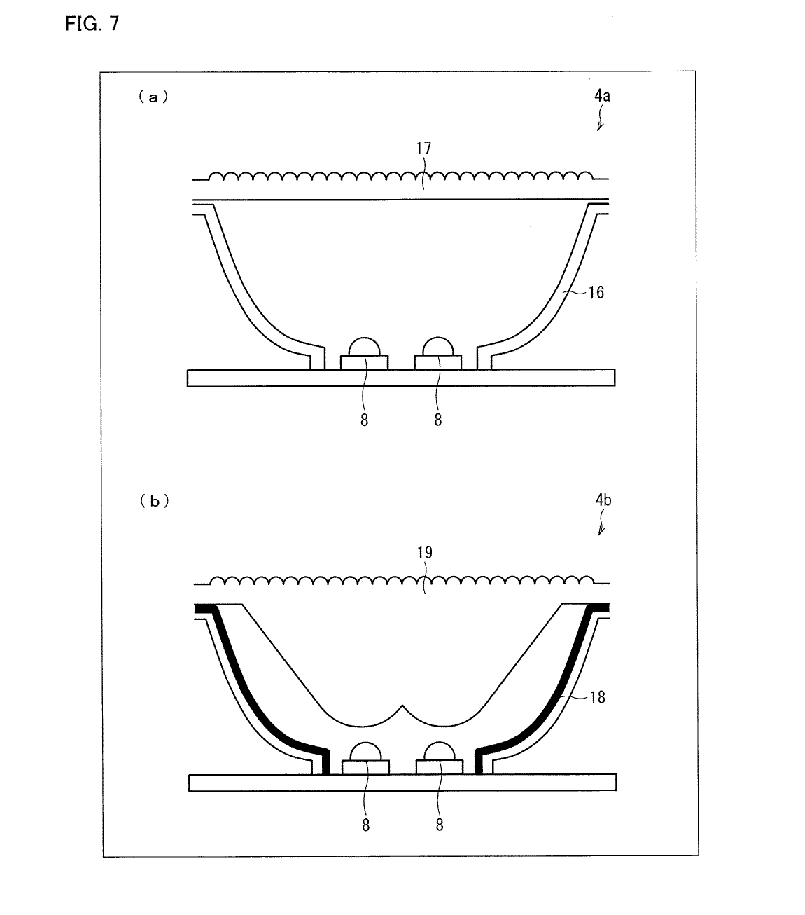

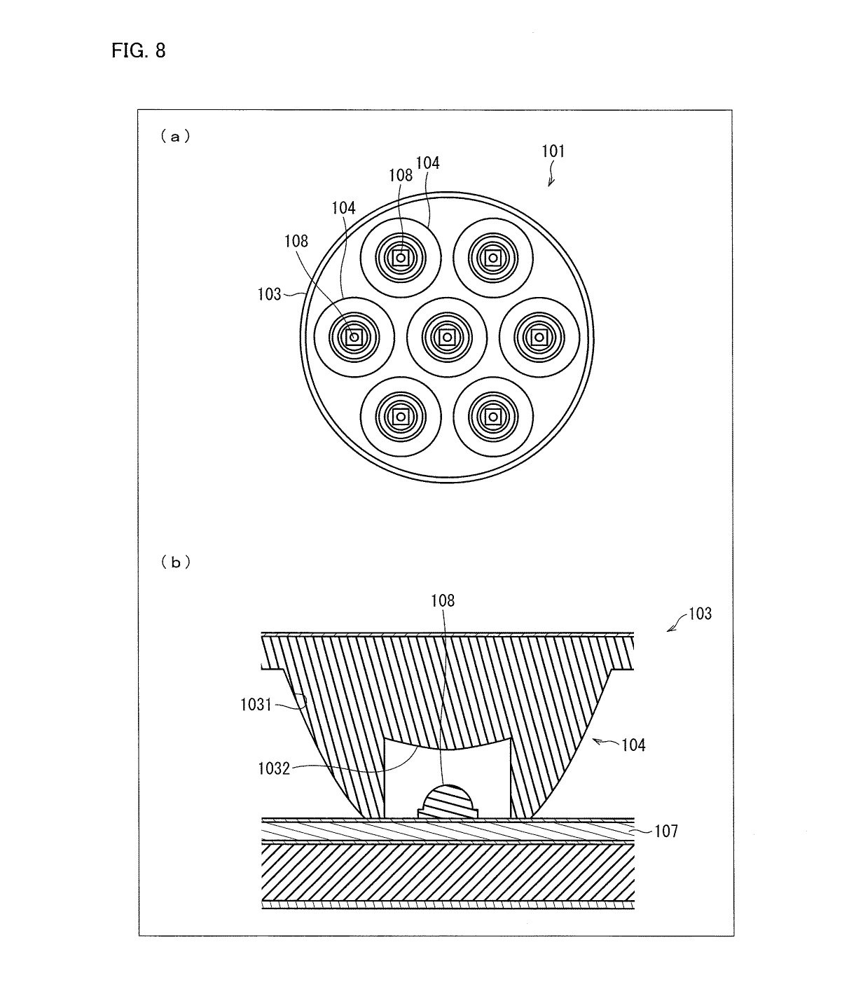

(a) of FIG. 5 is a perspective view illustrating a transmission unit and LEDs for a 150 W illumination device, and (b) of FIG. 5 is a plan view illustrating the illumination device viewed from a light-emitting direction. (c) of FIG. 5 is a perspective view illustrating a transmission unit and LEDs for a 100 W illumination device, and (d) of FIG. 5 is a plan view illustrating the illumination device viewed from a light-emitting direction. (e) of FIG. 5 is a perspective view illustrating a transmission unit and LEDs for a 60 W illumination device, and (f) of FIG. 5 is a plan view illustrating the illumination device viewed from a light-emitting direction.

FIG. 6

FIG. 6 is a plan view illustrating a surface of an LED substrate on which an LED is mounted.

FIG. 7

(a) of FIG. 7 is a cross-sectional view illustrating a configuration of a light-emitting section of a modified example of an embodiment of the present invention, and (b) of FIG. 7 is a cross-sectional view illustrating a configuration of a light-emitting section of another modified example of an embodiment of the present invention.

FIG. 8

(a) of FIG. 8 is a plan view illustrating a conventional illumination device viewed from a light-emitting direction, and (b) of FIG. 8 is a cross-sectional view of a part of the illumination device.

### DESCRIPTION OF EMBODIMENTS

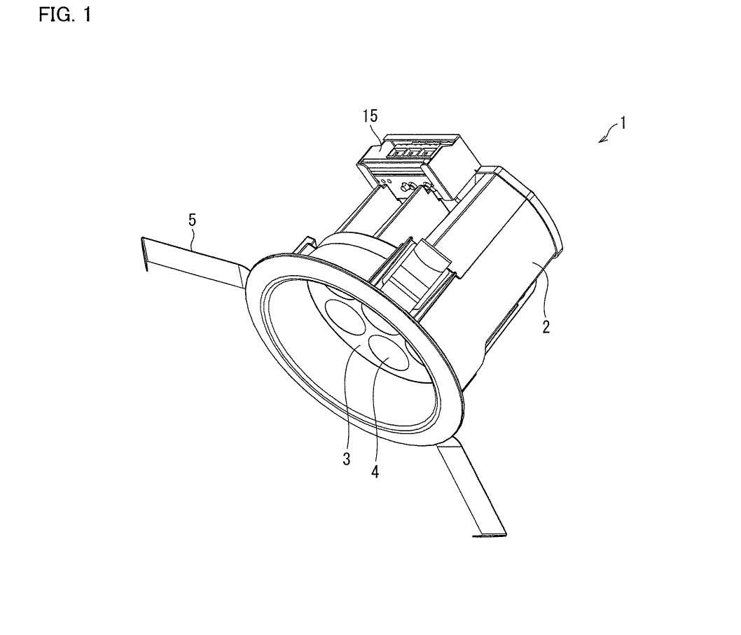

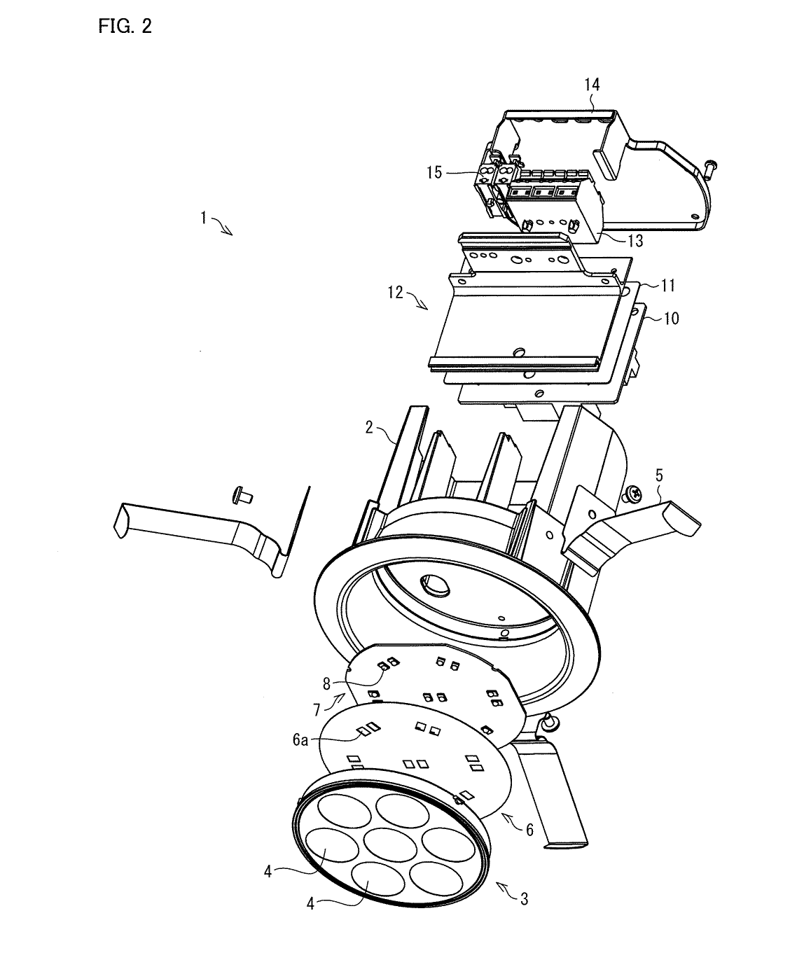

One embodiment of the present invention is described below with reference to FIGS. 1 through 7.

(Configuration of Illumination Device)

FIG. 1 is a perspective view illustrating an illumination device 1 of the present invention. The illumination device 1 is an illumination device that is employed, for example, as a downlight, and constituted by a cylindrical housing 2 and a transmission unit 3 which is inserted in the cylindrical housing 2. Light-emitting sections 4, each of which emits light, are provided in the transmission unit 3. Moreover, a mounting spring 5 for attaching the illumination device 1 on a ceiling or the like is provided on a rim of a circular opening of the housing 2.

FIG. 2 is an exploded perspective view illustrating the illumination device 1 viewed from a different angle. As illustrated in FIG. 2, the illumination device 1 includes the housing 2, the transmission unit 3, the mounting spring 5, a reflective sheet 6, an LED substrate 7, LEDs (light sources) 8, a circuit substrate 10, an insulation sheet 11, a terminal angle 12, a power-supply terminal board 13, a cover 14, and a light-control terminal board 15. The transmission unit 3, the reflective sheet 6, and the LED substrate 7 are piled in this order and inserted in the housing 2. The LEDs 8, which are light sources of the illumination device 1, are mounted on the LED substrate 7. An opening 6a is formed on the reflective sheet 6 in a position facing each of the LEDs 8.

A circuit that controls a driving of the LEDs 8 is provided on the circuit substrate 10, which is attached to the terminal angle 12 via the insulation sheet 11. The power-source terminal board 13 has a power-supply terminal for supplying electric power from outside. The light-control terminal board 15 has a light-control terminal for supplying a light-control signal from outside. After the terminal angle 12, to which the circuit substrate 10, the power-supply terminal board 13, and the light-control terminal board 15 are attached, is attached to the housing 2, the cover 14 is attached to the housing 2 in order to cover an opening of the housing 2. The mounting spring 5 is employed to fix the illumination device 1 to a mounting hole provided on a ceiling, a wall, or the like.

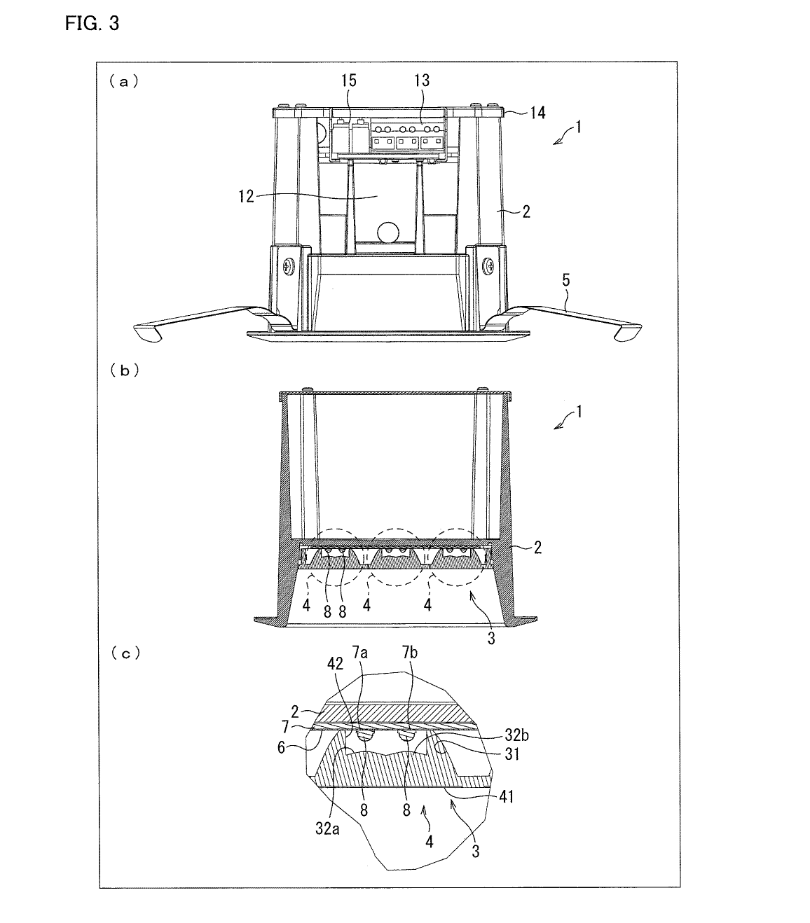

(a) of FIG. 3 is a lateral view illustrating the illumination device 1. As illustrated in (a) of FIG. 3, the terminal angle 12, to which the power-supply terminal board 13 and the light-control terminal board 15 are attached, is inserted in a side surface of the housing 2, and the cover 14 is attached to the housing 2 in order to cover the opening of the housing 2.

(b) of FIG. 3 is a cross-sectional view illustrating the illumination device 1. As illustrated in (b) of FIG. 3, one or two LEDs 8 are mounted in each of the light-emitting sections 4. A detailed configuration of the light-emitting sections 4 is illustrated in (c) of FIG. 3.

(c) of FIG. 3 is an enlarged cross-sectional view of a circled part indicated by the broken line in (b) of FIG. 3. As illustrated in (c) of FIG. 3, the reflective sheet 6 is provided on the substrate 7. The transmission unit 3 is mounted on the reflective sheet 6 and includes the light-emitting sections 4. A light-emitting section 4 has two LEDs 8, a reflective surface (reflective section) 31, which is formed on an inner surface of the light-emitting section 4, and two lighting lenses (lenses) 32a and 32b, which are formed in positions corresponding to the respective two LEDs 8. The two LEDs 8 are mounted in mounting areas 7a and 7b of the LED substrate 7, respectively. That is, a light-emitting section 4 has two mounting areas each of which is designed to be provided with an LED 8. The present embodiment describes an example in which two mounting areas are provided. However, the present invention is not limited to this, and three or more mounting areas can be provided.

The reflective surface 31 and the lighting lenses 32a and 32b are integrally formed as a part of the light-emitting section 4 formed in the transmission unit 3. The reflective surface 31 is formed so as to surround the two LEDs 8. Light received from the two LEDs 8 is reflected from the reflective surface 31 so as to travel in a light-emitting direction of the light-emitting section 4. This allows an increase in efficiency of use of light emitted from the LEDs 8.

Each of the lighting lenses 32a and 32b is formed in a convex shape toward a corresponding one of the two LEDs 8 so as to constitute a lens array in which the two lenses are combined. Each of the lighting lenses 32a and 32b collects light received from one of the LEDs 8 arranged in arrangement areas of the light-emitting section 4, which one of the LEDs 8 faces the each of the lighting lenses 32a and 32b. The each of the lighting lenses 32a and 32b (i) controls the light, which has been received from the corresponding one of the LEDs 8, to have a desired light distribution angle, and (ii) emits the light via an emitting surface 41. In the present embodiment, light emitted from an LED having a light distribution angle of 120°, which LED serves as an LED 8, is (i) controlled by each of the lighting lenses 32a and 32b to have an angle of 80°, and (ii) emitted from the emitting surface 41. Note that a light distribution angle of the LEDs 8 to be used is not limited to 120°. It is possible to use an LED having a wider light distribution angle or an LED having a high directivity. Further, control of a light distribution angle by a lighting lens is not limited to 120° as described above, and it is possible to (i) further reduce the light distribution angle or (ii) use a lens for causing light to be emitted at a wider light distribution angle.

In (c) of FIG. 3, an LED 8 is mounted in both of the mounting areas 7a and 7b. Note, however, that it is possible to mount an LED 8 in only one of the mounting areas 7a and 7b. In this case, a mounting area in which no LED 8 is mounted and a lighting lens face each other. In other words, the light-emitting section 4 (i) has the same number of lighting lenses as the number of the mounting areas and (ii) is arranged such that each of the lighting lenses and a corresponding one of the mounting areas face each other.

Moreover, the reflective sheet 6, which reflects light received from each of the two LEDs 8, is placed on a surface of the LED substrate 7. The reflective sheet 6 reflects, toward the light-emitting section 4, the light received from each of the two LEDs 8. This allows efficiency of use of light to be further increased. Furthermore, a back surface of the LED substrate 7 is in contact with the housing 2. This causes heat generated by the LEDs 8 to be conducted to the housing 2 and released from a side surface of the housing 2. As such, the housing 2 also functions as a heat sink.

(Configuration of Transmission Unit)

The following description will discuss a configuration of the transmission unit 3.

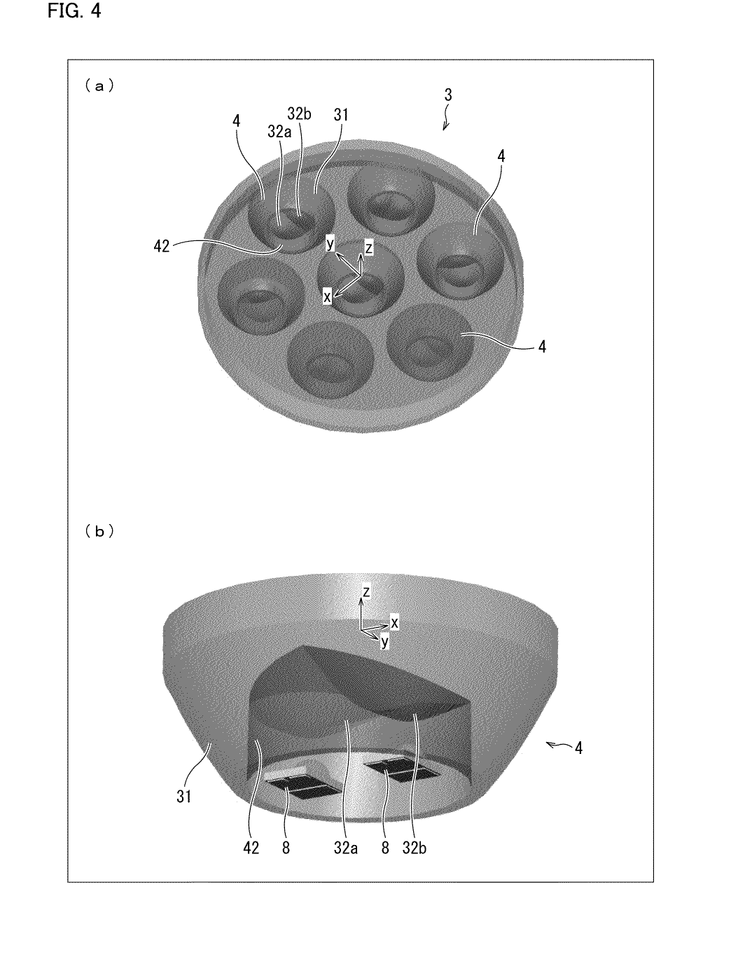

(a) of FIG. 4 is a perspective view illustrating the transmission unit 3, and (b) of FIG. 4 is an enlarged view of a part of the light-emitting sections 4 mounted on the transmission unit 3. In (a) of FIG. 4, light is emitted in a z-axis direction. As illustrated in (a) of FIG. 4, seven light-emitting sections 4, each of which has a convex shape, is provided in the transmission unit 3, and an inner plane of a side surface of each of light-emitting sections 4 (convex sections) serves as a reflective surface 31. Furthermore, a cylindrical concave section 42 is formed at an end of each of the light-emitting sections 4, which end is closer to the substrate 7 than an opposite end of the light-emitting section 4 is. In the concave section 42, two lighting lenses 32a and 32b are formed in positions corresponding to respective mounting areas 7a and 7b of the LED substrate 7. That is, the reflective surface 31 functioning as an internal reflective mirror is formed on the side surface of each of the light-emitting sections 4, and the reflective surface 31 and the lighting lenses 32a and 32b are integrated with one another.

In a state in which the transmission unit 3 is inserted in the illumination device 1, two LEDs 8 are in an opening of the concave 42 (see (b) of FIG. 4). Since the two LEDs 8 face the lighting lenses 32a and 32b respectively, it becomes possible to control a light distribution of light emitted from each of the two LEDs 8. As described above, in the present embodiment, the lighting lenses 32a and 32b control light distributions of the respective LEDs 8 to decrease from 120° to 80°. Note that, in (b) of FIG. 4, light is emitted in a z-direction.

As described above, in the illumination device 1, each of the light-emitting sections 4 has two mounting areas each of which is designed to be provided with an LED 8, so that a maximum of two LEDs 8 can be mounted in a single light-emitting section 4. As such, by changing the number of LEDs 8 to be mounted in each of the light-emitting sections 4, it is possible to manufacture a plurality of types of illumination devices that are different from each other in total number of the LEDs 8 to be employed.

Moreover, by mounting at least one LED 8 in each of the light-emitting sections 4, that is, by changing, to one or two, the number of the LEDs 8 to be mounted in each of the light-emitting sections 4, it becomes possible to manufacture, by use of identical transmission units 3, a plurality of types of illumination devices that are different from each other in brightness. In addition, since light is emitted from all of the light-emitting sections 4, it is possible to provide an illumination device that makes it possible to manufacture a plurality of models of the illumination device at a low cost, which plurality of models are different from each other in brightness but each of which plurality of models has a uniform luminance on the light-emitting surface as a whole.

(Specific Example of Transmission Unit)

As a specific example, three types of illumination devices, i.e., an illumination device having a comparable brightness to a 150 W incandescent bulb, an illumination device having a comparable brightness to a 100 W incandescent bulb, and an illumination device having a comparable brightness to a 60 W incandescent bulb are illustrated in FIG. 5.

(a) of FIG. 5 is a perspective view illustrating a transmission unit 3 and LEDs 8 of a 150 W illumination device 1a, and (b) of FIG. 5 is a plan view illustrating the illumination device la viewed from a light-emitting direction. In the illumination device 1a, seven light-emitting sections 4 are arranged in a form of a close-packed cubic lattice. Two LEDs 8 are mounted in each of the light-emitting sections 4, and 14 LEDs 8 in total are employed in the entire illumination device 1a. LEDs 8 for six light-emitting sections 4 which form an outermost group are arranged along a circumferential direction. In a case where (i) the LEDs 8 are arranged along the circumferential direction in this manner and (ii) a wiring line of each of the LEDs 8 is extracted to the outer side, it is possible to provide a heat releasing pattern sheet in a center of the transmission unit 3 so that the 12 LEDs 8 can share the heat releasing pattern sheet.

(c) of FIG. 5 is a perspective view illustrating a transmission unit 3 and LEDs 8 of a 100 W illumination device 1b, and (d) of FIG. 5 is a plan view illustrating the illumination device 1b viewed from a light-emitting direction. In the illumination device 1b, there are three light-emitting sections 4 in each of which two LEDs 8 are mounted, and there are four light-emitting sections 4 in each of which a single LED 8 is mounted. That is, ten LEDs 8 in total are employed in the entire illumination device 1b.

(e) of FIG. 5 is a perspective view illustrating a transmission unit 3 and LEDs 8 of a 60 W illumination device 1c, and (f) of FIG. 5 is a plan view illustrating the illumination device 1c viewed from a light-emitting direction. In the illumination device 1c, a single LED 8 is mounted in each of the light-emitting sections 4, and seven LEDs 8 in total are employed in the entire illumination device 1c.

None of the illumination devices 1a through 1c has a light-emitting section 4 in which no LED 8 is mounted. As such, none of the illumination devices 1a through 1c has luminance unevenness on a light-emitting surface. For example, in the illumination device 1b, a light-emitting section 4 in which a single LED 8 is mounted and a light emitting section 4 in which two LEDs 8 are mounted are different from each other in luminance of emitted light. However, when viewed from a certain distance, the illumination device 1b has a substantially uniform luminance on the light-emitting surface as a whole. Accordingly, there is no problem in terms of appearance in regular use.

Furthermore, the illumination devices 1a through 1c are manufactured by use of an identical transmission unit 3. As such, it becomes possible to reduce a manufacturing cost as compared with a case where different transmission units are used for respective types of illumination devices.

Note that in a light-emitting section 4 in which a single LED 8 is mounted, a position of the LED 8 is deviated from a center of an emitting opening. However, in the light-emitting section 4, a lighting lens 32 is provided in a position facing each LED 8. As such, it is possible to emit uniform light at a wide angle from the light-emitting section 4.

Accordingly, in the present embodiment, changing, to one or two, the number of LEDs 8 to be mounted in each of the light-emitting sections 4 makes it possible to manufacture, by use of identical transmission units 3, a plurality of types of illumination devices that are different from each other in brightness.

(Wiring Line Pattern of LED Substrate)

FIG. 6 is a plan view illustrating a surface of the LED substrate 7. As illustrated in FIG. 6, seven light-emitting sections 4 are arranged in a form of a close-packed cubic lattice, and 12 mounting areas (six mounting areas 7a and six mounting areas 7b) for light-emitting sections 4 which form an outermost group among the seven light-emitting sections 4 are arranged along a circumferential direction. As such, a wiring line pattern 7c for supplying electric power to the LEDs 8 (not shown in FIG. 6) that are mounted in the mounting areas 7a and 7b which form the outermost group can be continuously formed in a ring along a circumference of the LED substrate 7. This allows the wiring line pattern 7c to be easily formed.

Moreover, a large number of through holes 7d are formed in the LED substrate 7. These through holes 7d make it possible to accelerate heat conduction between a back surface and a front surface of the LED substrate 7. Further, since the through holes 7d become denser toward the LEDs 8, heat generated by the LEDs 8 can be conducted more efficiently to the back surface of the LED substrate 7. Furthermore, the through holes 7d can be also used for releasing an air bubble which is generated when a heat releasing sheet (not shown) is adhered.

(Modified Example of Light-Emitting Section)

The following description will discuss, with reference to FIG. 7, a modified example of a configuration of a light-emitting section. The present invention is not limited to the above-described configuration in which, in each of the light-emitting sections 4, a reflective surface 31 and lighting lenses 32a and 32b are integrally constituted.

(a) of FIG. 7 is a cross-sectional view illustrating a configuration of a light-emitting section 4a in accordance with the modified example of the present embodiment. The light-emitting section 4a includes two LEDs 8, a diffuse reflective plate 16, and a cover 17. That is, the light-emitting section 4a has, instead of a lighting lens, the diffuse reflective plate 16 as a reflective plate. Since the reflective plate 16 diffusely reflects light received from the LEDs 8, it is possible to emit uniform light at a wide angle from the light-emitting section 4a.

(b) of FIG. 7 is a cross-sectional view illustrating a configuration of a light-emitting section 4b in accordance with another modified example of the present embodiment. The light-emitting section 4b includes two LEDs 8, a mirror reflective plate 18, and a lighting lens 19. That is, in the light-emitting section 4b, a reflective plate and a lighting lens are formed separately.

Note that in each of the light-emitting sections 4a and 4b, one or two LEDs 8 can be mounted. In the light-emitting section 4b illustrated in (b) of FIG. 7, the mirror reflective plate 18 can be replaced with the diffuse reflective plate 16 illustrated in (a) of FIG. 7. Moreover, as a lighting lens, it is possible to employ the lighting lens 1032 illustrated in (b) of FIG. 8.

In the description above, a maximum of two LEDs can be mounted in each of the light-emitting sections. However, the number of LEDs that can be mounted in each of the light-emitting sections is not limited to this. For example, it is possible to employ a configuration in which the maximum number of LEDs that can be mounted in each of the light-emitting sections is three or greater. Moreover, in the present embodiment, all of the light-emitting sections included in the transmission unit have two arrangement areas. However, it is also possible to employ a configuration in which (i) only some of the light-emitting sections can each have a plurality of LEDs and (ii) the rest of the light-emitting sections can each have one LED. That is, the number of arrangement areas of each of the light-emitting sections does not have to be equal among the light-emitting sections. Furthermore, in the above description, seven light-emitting sections are formed in the transmission unit. However, the number of the light-emitting sections formed in the transmission unit is not limited to this, and can be (i) a plural number other than seven or (ii) one.

In the present embodiment, an illumination device employing an LED as a light source has been described. However, a light source of the illumination device is not limited to an LED but it is also possible to employ an EL (electroluminescence) or the like as a light source.

The illumination device in accordance with the present embodiment is preferably arranged such that the plurality of light sources are provided in such a manner that, in the set of the plurality of mounting areas, corresponding to each of the plurality of light-emitting sections, not all of the plurality of mounting areas but a mounting area(s) is provided with a light source(s).

According to the configuration above, the illumination device can share a light-emitting section with an illumination device in which the plurality of light sources are provided in such a manner that, in the set of the plurality of mounting areas, corresponding to each of the plurality of light-emitting sections, there is no mounting area that is provided with no light source.

The illumination device in accordance with the present embodiment is preferably arranged such that each of the plurality of light-emitting sections includes at least one lens for controlling directivity of light received from a corresponding one(s) of the plurality of light sources.

According to the configuration above, it is possible to control, by means of the at least one lens, directivity of light received from the corresponding one(s) of the plurality of light sources. This allows light to be emitted in a uniform distribution directly under the illumination device.

The illumination device of the present invention is preferably arranged such that each of the plurality of light-emitting sections includes a reflective section which surrounds a corresponding one(s) of the plurality of light sources and from which light from the corresponding one(s) of the plurality of light sources is reflected so that the light which has been reflected travels in a light-emitting direction of each of the plurality of light-emitting sections.

According to the configuration above, the reflective section reflects light received from the corresponding one(s) of the plurality of light sources so that the light which has been reflected travels in a light-emitting direction of each of the plurality of light-emitting sections. As such, efficiency of use of light can be increased.

The illumination device in accordance with the present embodiment is preferably arranged such that the at least one lens included in each of the plurality of light-emitting sections is a plurality of lenses; the number of the plurality of lenses is equal to the number of the plurality of mounting areas provided for each of the plurality of light-emitting sections; and the plurality of lenses face the respective plurality of mounting areas.

According to the configuration above, also in a light-emitting section in which a plurality of light sources are provided, a lens and a corresponding one of the plurality of light sources face each other. As such, the entire light-emitting surface of the illumination device can have a more uniform luminance.

The illumination device in accordance with the present embodiment is preferably arranged such that the reflective section included in each of the plurality of light-emitting sections is a diffuse reflective plate.

According to the configuration above, the diffuse reflective plate diffusely reflects light received from a corresponding one(s) of the plurality of light sources. As such, even in a case where no lens is provided in each of the plurality of light-emitting sections, it is possible to emit uniform light at a wide angle from each of the plurality of light-emitting sections.

The illumination device in accordance with the present embodiment is preferably arranged such that each of the plurality of light sources is an LED.

According to the configuration above, it is possible to provide an illumination device having a long service life and low power consumption.

The present invention is not limited to the above-described embodiments but allows various modifications within the scope of the claims. In other words, any embodiment derived from a combination of two or more technical means appropriately modified within the scope of the claims will also be included in the technical scope of the present invention.

### INDUSTRIAL APPLICABILITY

The present invention is suitable for a recessed illumination device (downlight, etc.) which needs to emit light that does not spread too wide, particularly in a case where the recessed illumination device is installed in a high position. The present invention is not limited to the recessed illumination device, but can be applied to a general illumination device (straight-type, square-type, etc.) which (i) employs a solid state element as a light source and (ii) requires adjustment of light distribution.

### REFERENCE SIGNS LIST

1: Illumination device
1a: Illumination device
1b: Illumination device
1c: Illumination device
2: Housing
3: Transmission unit
4: Light-emitting section
4a: Light-emitting section
4b: Light-emitting section
5: Mounting spring
6: Reflective sheet
6a: Opening
7: LED substrate
7a: Mounting area
7b: Mounting area
8: LED (light source)
10: Circuit substrate
11: Insulation sheet
12: Terminal angle
13: Power-supply terminal board
14: Cover
15: Light-control terminal board
16: Diffuse reflective plate (reflective section)
17: Cover
18: Mirror reflective plate (reflective section)
19: Lighting lens (lens)
31: Reflective surface (reflective section)
32: Lighting lens (lens)
32a: Lighting lens (lens)
32b: Lighting lens (lens)
41: Emitting surface
42: Concave section

1. An illumination device comprising:
a plurality of light sources;
a substrate; and
a plurality of light-emitting sections for emitting light received from the plurality of light sources, the plurality of light-emitting sections facing the substrate,
the substrate having, at a position corresponding to each of the plurality of light-emitting sections, a set of a plurality of mounting areas each being designed to be provided with a single light source,
the plurality of light sources being provided in such a manner that at least one light source is provided in the set of the plurality of mounting areas provided for each of the plurality of light-emitting sections.

2. The illumination device as set forth in claim 1, wherein:
the plurality of light sources are provided in such a manner that, in the set of the plurality of mounting areas, corresponding to each of the plurality of light-emitting sections, not all of the plurality of mounting areas but a mounting area(s) is provided with a light source(s).

3. The illumination device as set forth in claim 1, wherein:
each of the plurality of light-emitting sections includes at least one lens for controlling directivity of light received from a corresponding one(s) of the plurality of light sources.

4. The illumination device as set forth in claim 1, wherein:
each of the plurality of light-emitting sections includes a reflective section which surrounds a corresponding one(s) of the plurality of light sources and from which light from the corresponding one(s) of the plurality of light sources is reflected so that the light which has been reflected travels in a light-emitting direction of each of the plurality of light-emitting sections.

5. The illumination device as set forth in claim 3, wherein:
the at least one lens included in each of the plurality of light-emitting sections is a plurality of lenses;
the number of the plurality of lenses is equal to the number of the plurality of mounting areas provided for each of the plurality of light-emitting sections; and
the plurality of lenses face the respective plurality of mounting areas.

6. The illumination device as set forth in claim 4, wherein:
the reflective section included in each of the plurality of light-emitting sections is a diffuse reflective plate.

7. The illumination device as set forth in claim 1, wherein:
each of the plurality of light sources is an LED.
